(19) United States
(12) Patent Application Publication
(10) Pub. No.: US 2002/0075437 A1
(43) Pub. Date: Jun. 20, 2002

(54) Multi-domain vertically aligned liquid crystal display device

(76) Inventors: Masakazu Fukumoto, Hyogo (JP); Masahiro Yoshiga, Hyogo (JP)

Correspondence Address: U.S. Philips Corporation, 580 White Plains Road, Tarrytown, NY, 10591, US

(21) Appl. No.: 09/995,459

(22) Filed: Nov. 27, 2001

(30) Foreign Application Priority Data
Nov. 27, 2000 (JP) 2000-358596

(51) Int. Cl. G02F 1/1337

(52) U.S. Cl. 349/129

(57) ABSTRACT

An object of the invention is to improve a transmittance of a liquid crystal medium. A multi-domain type vertically aligned LCD device comprises: vertically aligned liquid crystal medium and substrates sandwiching it; pixel electrode 1A formed on one of the substrates; and bus line 5 located near the pixel electrode 1A and applying a signal to the pixel electrode, wherein a region of the liquid crystal medium corresponding to the pixel electrode 1A is separated by slit patterns formed in the pixel electrode 1A so that the separated regions cause control-direction for orientation of the liquid crystal medium to be differed. The slit patterns comprise straight line slit patterns 2n1, 2n2, 2m1, 2m2 oriented at a predetermined angle. Each of the straight line slit patterns has at least one bridge 3n1, 3n2, 3m1, 3m2 connecting between part areas of the pixel electrode, separated by the slit pattern. Positions and the number of bridges in the straight slit pattern is selected so as to optimize an optical transmittance of the liquid crystal medium.

### BACKGROUND OF THE INVENTION

1. Field of the Invention

The present invention relates to a liquid crystal display device. In particular, the present invention relates to a multi-domain vertically aligned liquid crystal display device.

2. Description of Related Art

A liquid crystal display device of this type is disclosed, e.g. in a publication of Japanese Patent No. 2,947,350.

In the prior art described in the publication, a protrusion pattern or a slit pattern within a pixel electrode is provided on at least one of two opposed substrates sandwiching a vertically aligned liquid crystal medium, so that division of alignment is realized such that areas delimited by the patterns have different alignment control directions of the liquid crystal medium. According to this constitution, it is possible to improve a viewing angle characteristic without a rubbing process as an alignment process for the liquid crystal while utilizing a high contrast ratio and a high operating speed that are inherent in the vertically aligned liquid crystal.

However, in the above-mentioned publication, there is no description about a scheme to optimize the patterns for a transmission characteristic of the liquid crystal medium. For liquid crystal display devices, a transmission property of the liquid crystal medium that makes optical modulation is an important parameter for determining its display image quality, especially a brightness of images and is not negligible.

### SUMMARY OF THE INVENTION

Therefore, the object of the present invention is to provide a liquid crystal display device which can improve transmittance of a liquid crystal medium.

In order to achieve the above-mentioned object, a liquid crystal display device of one aspect according to the present invention is a multi-domain vertically aligned liquid crystal display device, comprising: a liquid crystal medium which is vertically aligned under no electric field while being in contact with an orientation layer; two opposite substrates sandwiching the liquid crystal medium; pixel electrodes formed on one of the substrates; and bus-lines arranged in proximity to the pixel electrodes, for applying signals to the pixel electrodes, wherein an area corresponding to the pixel electrode in the liquid crystal medium is divided by at least a slit pattern formed in the pixel electrode, and the divided part areas cause controlling directions of orientation for the liquid crystal medium to be differed, wherein the slit pattern includes at least one straight-line-shaped slit pattern oriented at a predetermined angle, the straight-line-shaped slit pattern having at least one bridge connecting between part areas of the pixel electrode that are separated by that slit pattern, wherein a position and/or the number of the bridges in the straight-line-shaped slit pattern are/is chosen so that an optical transmittance of the liquid crystal medium becomes optimal.

A liquid crystal display device of another aspect according to the present invention is a multi-domain vertically aligned liquid crystal display device, comprising: a liquid crystal medium which is vertically aligned under no electric field while being in contact with an orientation layer; two opposite substrates sandwiching the liquid crystal medium; pixel electrodes formed on one of the substrates; and bus-lines arranged in proximity to the pixel electrodes, for applying signals to the pixel electrodes, wherein an area corresponding to the pixel electrode in the liquid crystal medium is divided by at least a slit pattern formed in the pixel electrode, and the divided part areas cause controlling directions of orientation for the liquid crystal medium to be differed, wherein the slit pattern includes one or more straight-line-shaped slit patterns oriented at a predetermined angle, each of the straight-line-shaped slit patterns having a single bridge connecting between part areas of the pixel electrode that are separated by that slit pattern, wherein the bridge is formed at a center position of the straight-line-shaped slit pattern.

In addition, a liquid crystal display device of a further aspect according to the present invention is a multi-domain vertically aligned liquid crystal display device, comprising: a liquid crystal medium which is vertically aligned under no electric field while being in contact with an orientation layer; two opposite substrates sandwiching the liquid crystal medium; pixel electrodes formed on one of the substrates; and bus-lines arranged in proximity to the pixel electrodes, for applying signals to the pixel electrodes, wherein an area corresponding to the pixel electrode in the liquid crystal medium is divided by at least a slit pattern formed in the pixel electrode, and the divided part areas cause controlling directions of orientation for the liquid crystal medium to be differed, wherein the slit pattern includes one or more straight-line-shaped slit patterns oriented at a predetermined angle, each of the straight-line-shaped slit patterns having a single bridge connecting between part areas of the pixel electrode that are separated by that slit pattern, wherein the bridge is formed with a deviation from a center position of the straight-line-shaped slit pattern.

In each aspect mentioned above, the straight-line-shaped slit pattern may extend at an angle of 45 and/or 135 degrees where a horizontal direction in a display screen of the liquid crystal display device is zero degree.

Furthermore, the other of the substrates may provided with an opposite protrusion or slit pattern extending substantially in parallel with a direction of the associated straight-line-shaped slit pattern of the one substrate side, and an area corresponding to the pixel electrode in the liquid crystal medium may be divided by the slit pattern and the opposite protrusion or slit pattern, so that the divided part areas can cause controlling directions of orientation for the liquid crystal medium to be differed.

The inventors have found that: when a larger number of the bridges exist in the straight line shaped slit pattern, an undesirable electric field is distributed in the liquid crystal medium; and this results in more dark images since optical transmission of the liquid crystal is more difficult in the case of driving the liquid crystal medium into a bright state.

The inventors have also recognized that: even in the case of a single bridge, changing of the position of the bridge in the straight line shaped slit pattern makes the distribution of the electric field in the liquid crystal medium to be varied. On the basis of such recognition, it has been further found that the liquid crystal medium can have a good optical transmittance ratio by disposing the bridge at a location more remote from or closer to a source or gate bus-line that applies a signal to the pixel electrode, depending on the slit position in the pixel electrode.

Therefore, by adopting a constitution of the aspect mentioned above, it is possible to increase the transmittance of the liquid crystal medium and to contribute to a higher display quality.

### BRIEF DESCRIPTION OF THE DRAWINGS

FIG. 1 is a schematic plan view showing a structure of a pixel electrode and its surroundings according to the first embodiment of the present invention.

FIG. 2 is a sectional view that schematically shows a structure of the liquid crystal display panel having a pixel electrode of the structure of FIG. 1.

FIG. 3 is a schematic plan view of a structure of a pixel electrode and its surroundings according to the second embodiment of the present invention.

FIG. 4 is a schematic plan view of a structure of a pixel electrode and its surroundings according to the third embodiment of the present invention.

FIG. 5 is a schematic plan view of a structure of a pixel electrode and its surroundings according to the fourth embodiment of the present invention.

FIG. 6 is an illustration of a comparison example for explaining an advantage of the respective embodiments of the present invention.

FIG. 7 is an illustration of an alternative of the second embodiment of the present invention.

### DESCRIPTION OF THE PREFERRED EMBODIMENT(S)

Now, the above-mentioned aspects and other aspects according to the present invention will be described in more detail with reference to the drawings attached hereto.

[Embodiment 1]

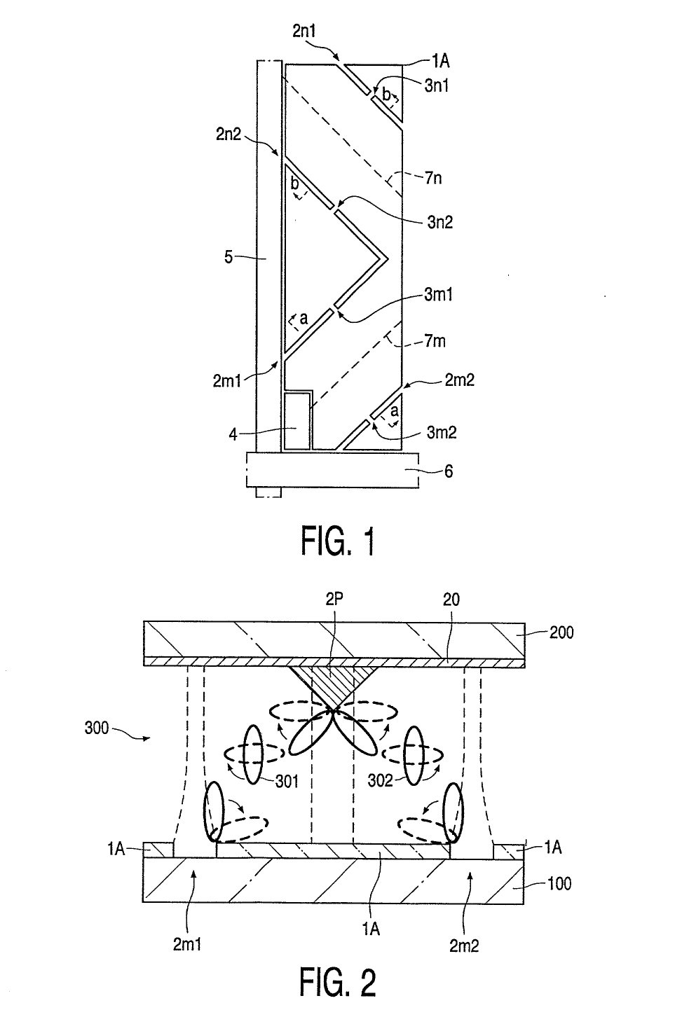

FIG. 1 schematically shows a structure of a pixel electrode and its surroundings that are used in a liquid crystal display device of one embodiment according to the present invention.

In FIG. 1, a pixel electrode 1A, which consists of an optical transmissive material that is suitably used for, e.g. a transmission type liquid crystal display, has slit patterns for the division of alignment as described above. Such slit patterns include straight line shaped slit patterns 2n1, 2n2 extending at an angle of 135°, in the case where horizontal direction and vertical direction in a display screen of the liquid crystal display device are set at angles of 0°, 90°, respectively, and straight line shaped slit patterns 2m1, 2m2 extending at an angle of 45° in the same case.

The slit pattern 2n2 and the slit pattern 2m1 are connected at their one ends around the rightward center of the pixel electrode 1A that is in a shape of substantially a rectangle in this example, and are extended in a “>” form. Accordingly, the center left side portion of the pixel electrode 1A forms an area of a right angled isosceles triangle of which an oblique side is in a vertical direction.

The slit pattern 2n1 and 2m2 are extended in such a manner that they separate the rectangular pixel electrode 1A into a right upper side corner portion and a right lower side corner portion, respectively, the corner portions forming areas of, e.g. right angled isosceles triangles, respectively.

These straight line shaped patterns comprise a slit corresponding to a continuous cavity of the pixel electrode and bridges 3n1, 3n2, 3m1, 3m2 making connections between areas within the pixel electrode, the areas being separated by the slit pattern. As shown in the Figure, one bridge is formed for one straight line shaped slit pattern, and the position at which the bridge is formed is substantially at a center of the straight line shaped slit pattern.

As shown in the Figure, these bridges are in form of crossing over an extending direction of the slit at right angles, and thereby the connection between the separated areas of the pixel electrode is made at the shortest distance, so that there is an advantageous aspect that the resistance of the pixel electrode is reduced.

An active element, e.g. a TFT (thin film transistor) 4 is disposed at the left lower side corner of the pixel electrode 1A. A drain electrode of the TFT 4 is usually coupled to the pixel electrode 1A (the description of the connection form is omitted).

The so-called source bus-line 5 runs on the left side of the pixel electrode 1A in a vertical direction of the display screen, and the so-called gate bus-line 6 runs on the bottom side of the pixel electrode 1A in the horizontal direction of the same. The bus-line 5 is connected to a source electrode of the TFT 4, and the bus-line 6 is connected to a gate electrode of the TFT 4 (the description of the connection form is omitted).

The TFT 4 is made active by a scanning line drive signal applied to the gate bus-line 6 and operated to cause the pixel electrode 1A to apply a voltage according to a pixel information signal applied to the source bus-line 5 to the liquid crystal medium situated on the upper side of the pixel electrode (above the surface of a sheet of the Figure).

It should be noted that the pixel electrode 1A and the bus-lines 5, 6 are formed on one substrate, and the liquid crystal medium is sandwiched between the one substrate and another substrate opposed thereto. An orientation (alignment) film is made on each of contact surfaces of the substrates for the liquid crystal medium, the orientation film making the liquid crystal molecules to be vertically oriented (aligned) when no electric field exists. On the other hand, the other substrate is provided with a color filter and a transparent common electrode, whereby the sandwiched liquid crystal portion is applied with a voltage for each pixel in cooperation with the pixel electrode 1A.

The pixel electrode 1A corresponds to any one of pixels of primary color components (for example, red (R), green (G), blue (B)). So, a great number of the pixel electrodes each having a shape and structure like the pixel electrode 1A are usually arranged over the display area in association with the color filter in order to perform full-color display. For example, the pixel electrodes are lined up as a row such that they are arranged in the order of R, G, B, R, G, B, . . . in a horizontal direction of the display area, and they are also arranged in the similar order on the upper and lower sides of the row.

FIG. 2 schematically shows an “a-a” sectional structure of a liquid crystal display device (panel) having a constitution of FIG. 1.

One glass substrate 100 is provided with the above-described pixel electrode 1A, and another glass substrate 200 situated opposite to it is provided with a common electrode 20. The other substrate 200 is also provided with a protrusion (pattern) 2P for the division of alignment. Dashed lines 7n, 7m in FIG. 1 indicate a peak of the protrusion in association with the pixel electrode 1A.

Between the substrates, an appropriate liquid crystal material is enclosed, the material being, in this example, a liquid crystal medium 300 of a negative type whose liquid crystal molecules incline along a direction perpendicular to the electric field when a voltage is applied thereto while the molecules are oriented perpendicularly to a surface of the vertical orientation film in the case where the molecules are in contact with the vertical orientation film under no electric field.

It should be noted that components such as the vertical orientation film, the color filter, the polarizer, etc. are omitted for simplifying the description. The detailed description of these components relies on the above-cited prior art reference and so on.

Now, assuming that a sufficient (white drive) voltage is applied between the pixel electrode 1A and the common electrode 20, an electric field of electric lines of force is developed as shown by dashed lines in FIG. 2. The electric field is such a form that the electric lines of force are partly curved due to an influence of (the cavity slit portion of) the slit patterns 2m1, 2m2. Such a field allows the liquid crystal molecule 301 to rotate or incline clockwise in a domain between the protrusion pattern 2P and the slit pattern 2m1 while the liquid crystal molecule 302 is allowed to rotate or incline counter-clockwise in a domain between the protrusion pattern 2P and the slit pattern 2m2. Thus, it is possible to make the controlling-directions of alignment of liquid crystal molecules to be differed within the same pixel.

Such division of alignment is shown in the “a-a” sectional view, but also the similar behavior is shown in a “b-b” sectional view (see FIG. 1). However, the “b-b” sectional view is in the different direction from the “a-a” direction by 90°, so that in the “b-b” sectional view the division of alignment is made different by 90° from the orientation controlling directions of liquid crystal molecules shown in FIG. 2, taking account of the whole of the pixel electrode.

Hence, four orientation controlling directions are defined within one pixel.

[Embodiment 2]

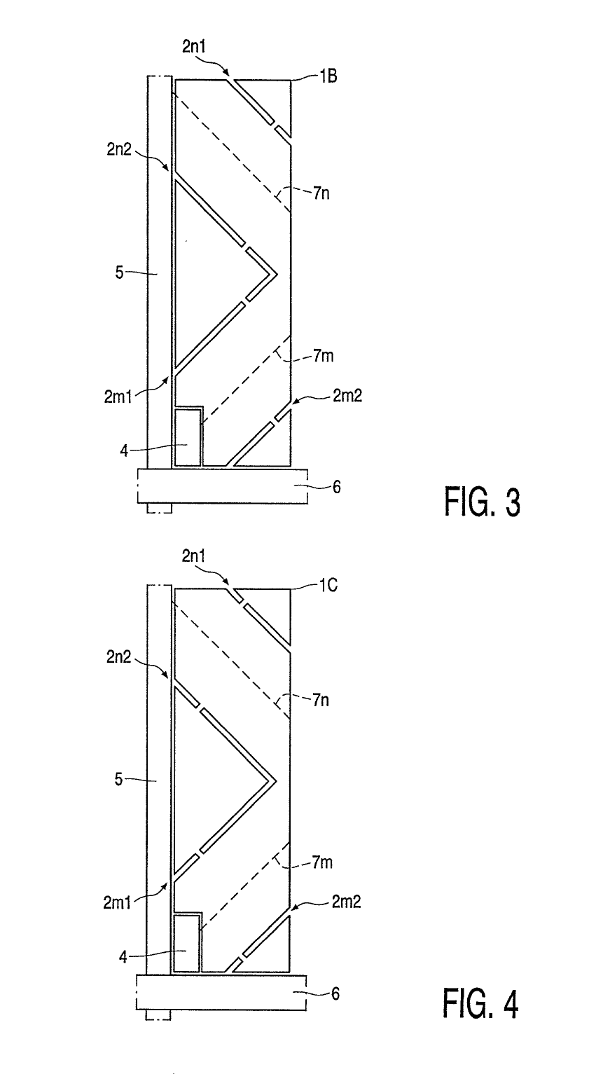

FIG. 3 schematically shows in a plan view a structure of a pixel electrode and its surroundings used in a liquid crystal display device of another embodiment according to the present invention.

In this embodiment, as shown in the Figure, one bridge is formed for one straight line shaped slit pattern, and the bridge forming position is situated at the rightward-leaning side of that in the Embodiment 1, namely at a location more remote from the bus-line 5 connecting to the source electrode of the TFT 4 connected to the pixel electrode in question.

[Embodiment 3]

FIG. 4 schematically shows in a plan view a structure of a pixel electrode and its surroundings using in a liquid crystal display device of a further embodiment according to the present invention.

In this embodiment, as shown in the Figure, one bridge is formed for one straight line shaped slit pattern, and the bridge forming position is situated at the leftward-leaning side of that in the Embodiment 1, that is, at a location nearer to the bus-line 5 connecting to the source electrode of the TFT 4 connected to the pixel electrode in question.

[Embodiment 4]

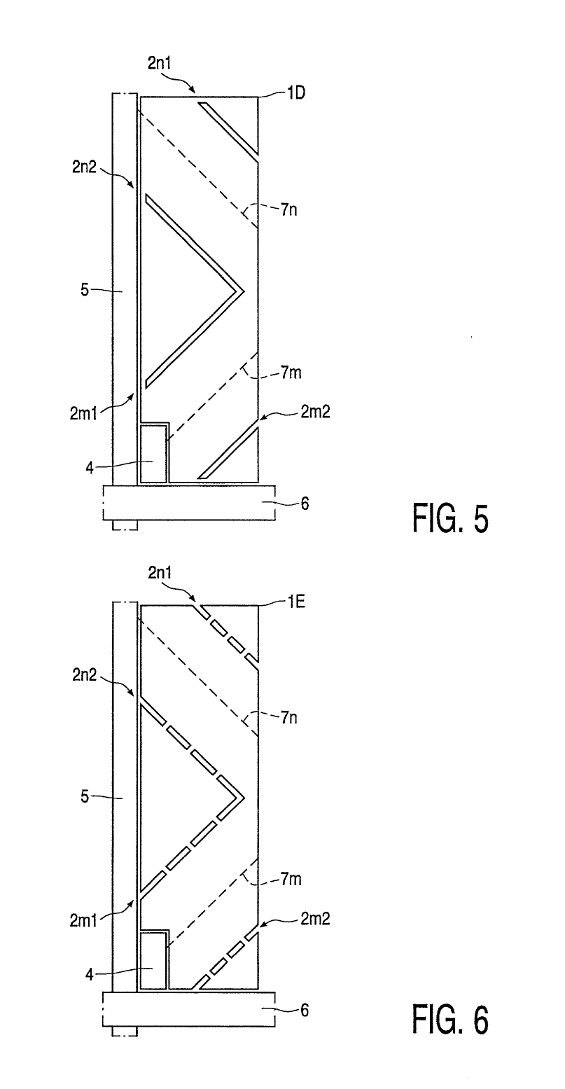

FIG. 5 schematically shows in a plan view a structure of a pixel electrode and its surroundings used in a liquid crystal display device of yet another embodiment according to the present invention.

In this embodiment, as shown in the Figure, one bridge is formed for one straight line shaped slit pattern, and the bridge forming position is situated at one end portion of the straight line shaped slit pattern, in other words, at a location serving as an outline portion or an edge portion of the pixel electrode on the plan view.

For the purpose of explanation of the effect and advantage engaged in the four embodiments mentioned above, an example for comparison therewith is shown in FIG. 6.

In FIG. 6, a plurality of bridges, three bridges in this example are formed for one straight line shaped slit pattern, and their forming positions are situated substantially at uniformed intervals in the straight line shaped slit pattern. Such a slit pattern having a plurality of bridges has advantages in that the bridges can guarantee compensation for lack of any bridge when the pixel electrode is formed and in that resistivity of the pixel electrode can be reduced.

Comparing a transmittance of the liquid crystal cell constructed of the pixel electrode of this comparison example with transmittances of the liquid crystal cells constructed of the pixel electrodes of the above-mentioned Embodiments 1-4, the following results have been obtained. It has been checked that: relative to the transmittance obtained in the comparison example, the Embodiment 1 presents promotion of about 4%; the Embodiment 2, promotion of about 10%; and the Embodiments 3 and 4, promotion of about 6%, respectively. Therefore, in configuration of the slit pattern and bus-line formation as mentioned above, it is one of the best modes that a bridge is located at a position more remote from the bus-line.

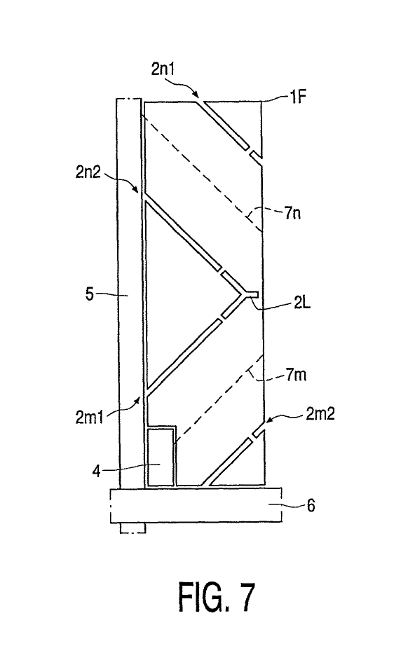

The other one of the best modes is a slit pattern shown in FIG. 7. In the example of FIG. 7, from the coupling portion of the straight line shaped slit patterns 2n2, 2m1 that show a “>” shape, the associated slit extends further horizontally, that is, rightward or in a direction that gets far away from the bus-line 5. It has been appreciated that by the configuration with such an extending portion 2L, it is possible to further increase transmittance of the liquid crystal cell than that of the Embodiment 2.

It should be noted that other various modifications can be realized in the present invention. For instance, the extending direction of the slit pattern and/or the protrusion pattern and the divisional geometry of domains thereby obtained may be modified.

Although the active matrix type liquid crystal display device has been described in the above embodiments, the present invention can be applied to ones of passive matrix type.

The preferred embodiments described herein are therefore illustrative and not restrictive, the scope of the present invention being indicated by the appended claims and all variations which come within the meaning of the claims are intended to be embraced therein.

1. A multi-domain vertically aligned liquid crystal display device, comprising:
a liquid crystal medium which is vertically aligned under no electric field while being in contact with an orientation layer;
two opposite substrates sandwiching the liquid crystal medium;
pixel electrodes formed on one of the substrates; and
bus-lines arranged in proximity to the pixel electrodes, for applying signals to the pixel electrodes,
wherein an area corresponding to the pixel electrode in the liquid crystal medium is divided by at least a slit pattern formed in the pixel electrode, and the divided part areas cause controlling-directions of orientation for the liquid crystal medium to be differed,
wherein the slit pattern includes at least one straight-line-shaped slit pattern oriented at a predetermined angle, the straight-line-shaped slit pattern having at least one bridge connecting between part areas of the pixel electrode that are separated by that slit pattern,
wherein a position and/or the number of the bridges in the straight-line-shaped slit pattern are/is chosen so that an optical transmittance of the liquid crystal medium becomes optimal.

2. A multi-domain vertically aligned liquid crystal display device, comprising:
a liquid crystal medium which is vertically aligned under no electric field while being in contact with an orientation layer;
two opposite substrates sandwiching the liquid crystal medium;
pixel electrodes formed on one of the substrates; and
bus-lines arranged in proximity to the pixel electrodes, for applying signals to the pixel electrodes,
wherein an area corresponding to the pixel electrode in the liquid crystal medium is divided by at least a slit pattern formed in the pixel electrode, and the divided part areas cause controlling directions of orientation for the liquid crystal medium to be differed,
wherein the slit pattern includes one or more straight-line-shaped slit patterns oriented at a predetermined angle, each of the straight-line-shaped slit patterns having a single bridge connecting between part areas of the pixel electrode that are separated by that slit pattern,
wherein the bridge is formed at a center position of the straight-line-shaped slit pattern.

3. A multi-domain vertically aligned liquid crystal display device, comprising:
a liquid crystal medium which is vertically aligned under no electric field while being in contact with an orientation layer;
two opposite substrates sandwiching the liquid crystal medium;
pixel electrodes formed on one of the substrates; and
bus-lines arranged in proximity to the pixel electrodes, for applying signals to the pixel electrodes,
wherein an area corresponding to the pixel electrode in the liquid crystal medium is divided by at least a slit pattern formed in the pixel electrode, and the divided part areas cause controlling directions of orientation for the liquid crystal medium to be differed,
wherein the slit pattern includes one or more straight-line-shaped slit patterns oriented at a predetermined angle, each of the straight-line-shaped slit patterns having a single bridge connecting between part areas of the pixel electrode that are separated by that slit pattern,
wherein the bridge is formed with a deviation from a center position of the straight-line-shaped slit pattern.

4. A liquid crystal display device as defined in claim 1, 2 or 3, CHARACTERIZED in that the straight-line-shaped slit pattern extends at an angle of 45 and/or 135 degrees where a horizontal direction in a display screen of the liquid crystal display device is zero degree.

5. A liquid crystal display device as defined in claim 1, 2, 3 or 4, CHARACTERIZED in that the other of the substrates is provided with an opposite protrusion or slit pattern extending substantially in parallel with a direction of the associated straight-line-shaped slit pattern of the one substrate side, in that an area corresponding to the pixel electrode in the liquid crystal medium is divided by the slit pattern and the opposite protrusion or slit pattern, and in that the divided part areas cause controlling directions of orientation for the liquid crystal medium to be differed.
